(19) United States
(12) Patent Application Publication
(10) Pub. No.: US 2009/0280003 A1
(43) Pub. Date: Nov. 12, 2009

(54) METHOD AND SYSTEM FOR MONITORING PARTICULATE

(76) Inventors: Jesse Jay Schriner, Sammamish, WA (US); Sabra Ingar Schriner, Sammamish, WA (US); Terry Lewis Farmer, Kearney, MO (US); Joseph Patrick Dougherty, Erie, PA (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/117,508

(22) Filed: May 8, 2008

(51) Int. Cl. F02C 9/00; G01N 21/85; F02C 7/00

(52) U.S. Cl. 415/13; 73/23.31; 415/118

(57) ABSTRACT

Methods and systems for monitoring particulate in a flow of gases are provided. A particulate monitor system includes an emitter coupled to an exhaust duct and downstream from a turbine engine. The emitter emits light at a predetermined intensity through a flow of gases discharged from the turbine engine into the exhaust duct. A receiver is coupled to the exhaust duct and oriented to receive at least a portion of the light emitted from the emitter. The receiver generates a first signal indicative of an intensity of the emitted light received. A controller is coupled in communication with the receiver. The controller is configured to generate, based on the first signal, an output signal corresponding to a variation in intensity of the portion of the emitted light received. A monitor in communication with the controller receives the output signal from the controller.

### BACKGROUND OF THE INVENTION

The field of the disclosure relates generally to gas turbine engines and, more particularly, to methods and systems for monitoring particulate in gas turbine engine exhaust streams.

Known gas turbine engines are used as a power source within a variety of applications. To protect the engine from the environment and to shield the surrounding environment from the gas turbine engine, at least some known gas turbine engines are housed within an engine assembly compartment that includes an inlet area, an exhaust area, such as an exhaust duct, and an engine area that extends between the inlet area and the exhaust area. For example, in a power generation facility, where the gas turbine engine is used as a power source for an electrical generator, the engine may be housed inside a compartment that reduces noise and heat generated during engine operation.

Within at least some known engine compartments, the inlet area includes ducts that route ambient air from outside the compartment into the engine compartment for cooling the engine and for supplying air to the engine. During operation the engine generates combustion gases that are channeled through an exhaust duct from the engine compartment. To comply with environmental particulate monitoring requirements, for example, at least some facilities monitor the flow of gas emissions through the exhaust duct. Moreover, at least some known gas turbine engines include a monitor that measures the amount of particulate in the flow of gases from the gas turbine engine. More specifically, in subsequent systems, as particulate flows between a transmitter and a receiver, the momentary blockage of an emitted beam of light by the particulate matter causes a modulating signal to be transmitted from the transmitter. The amplitude of the modulated signal increases as particulate concentration increases. The receiver senses the signal modulation and converts it to a proportional particulate concentration with a microprocessor.

Known monitors respond only to particulate moving through the exhaust duct. More specifically, known monitors measure signal variations resulting from moving particles rather than from a diminishing intensity of the light beam, and as such, such monitors are relatively unaffected by particulate accumulation on the receiver. Over time, continued operation with increased accumulation on the receiver may lead to erroneous particulate readings and increased manufacturing costs. Accordingly, at least some known gas turbine engines use a separate monitor to detect emissions for preventative maintenance. However, the monitor does not continuously monitor the amount of particulate matter and, thus, may not detect the amount of particulate at a given time.

### BRIEF DESCRIPTION OF THE INVENTION

In one embodiment, a method for monitoring particulate in a flow of gases generated by a means for transportation is provided. The method comprises emitting a beam of light at a predetermined intensity into the flow of gases, detecting at least a portion of the beam of light that is attenuated by particles in the flow of gases, determining, by comparing the attenuated beam to the emitted beam, a variation in intensity of the beam of light due to the particles attenuating the beam of light, and comparing the variation to a predetermined threshold value to generate an output signal indicative of an amount of particulate entrained in the flow of gases.

In another embodiment, a system for monitoring particulate in the flow of gases generated by a means for transportation is provided. The system includes an emitter coupled to an exhaust duct and downstream from a turbine engine. The emitter emits light at a predetermined intensity through a flow of gases discharged from the turbine engine into the exhaust duct. A receiver is coupled to the exhaust duct and oriented to receive at least a portion of the light emitted from the emitter. The receiver generates a first signal indicative of an intensity of the emitted light received. A controller is coupled in communication with the receiver. The controller is configured to generate, based on the first signal, an output signal corresponding to a variation in intensity of the portion of the emitted light received. A monitor is in communication with the controller. The monitor receives the output signal from the controller.

In yet another embodiment, a gas turbine engine system is provided. The gas turbine engine system includes a gas turbine engine including a combustion exhaust duct, and a particulate monitor system. The particulate monitoring system includes an emitter coupled to the exhaust duct downstream from the gas turbine engine. The emitter emits light at a predetermined intensity through a flow of gases discharged from the gas turbine engine. A receiver is coupled to the exhaust duct and oriented to receive at least a portion of light emitted from the emitter. The receiver generates a first signal indicative of an intensity of the emitted light received. A controller is coupled in communication with the receiver. The controller receives the first signal and generates an output signal corresponding to a variation in intensity of the emitted light. A monitor in communication with the controller. The monitor receives output signals from the controller.

### BRIEF DESCRIPTION OF THE DRAWINGS

FIG. 1 is a schematic illustration of an exemplary gas turbine engine;

FIG. 2 is a schematic illustration of an exemplary gas turbine generator compartment that may be used with the gas turbine engine shown in FIG. 1; and

FIG. 3 is a schematic illustration of an exemplary particulate monitor system that may be used with the gas turbine engine shown in FIG. 1.

### DETAILED DESCRIPTION OF THE INVENTION

It is desirable to have a particulate monitor system that continuously monitors the amount of particulate entrained in a flow of gases, such as combustion gases. It is desirable that the particulate entrained in the flow of gases be monitored from a remote location.

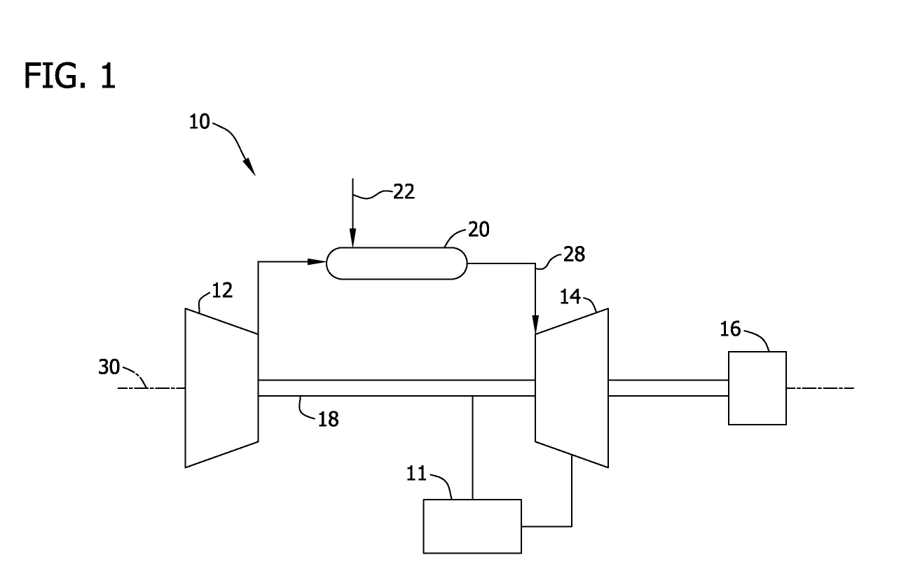

FIG. 1 is a schematic illustration of an exemplary gas turbine engine 10, suitable for supplying power to a means for transportation, such as a land vehicle, an aircraft, a spacecraft or a marine vessel. In one embodiment, gas turbine engine 10 is a locomotive or railroad engine, controlled by a controller 11, and coupled to supply power to move a train including one or more railcars, for example. In alternative embodiments, gas turbine engine 10 is a marine engine suitable for supplying power to move a ship or a boat, for example. In a further alternative embodiment, gas turbine engine 10, such as a 7FB gas turbine engine commercially available from General Electric Company, Greenville, S.C., is coupled to supply power to an electric generator. In alternative embodiments, gas turbine engine 10 may be any suitable gas turbine engine.

In the exemplary embodiment, controller 11 is a processor-based system that includes engine control software that enables controller 11 to perform as described herein. As used herein, the term processor is not limited to only integrated circuits referred to in the art as processors, but rather broadly refers to computers, processors, microprocessors, microcontrollers, microcomputers, programmable logic controllers, application specific integrated circuits (ASIC), logic circuits, and any other programmable circuits or processors capable of executing the system as described herein.

In the exemplary embodiment, gas turbine engine 10 includes a compressor 12 and a turbine 14 coupled along a single monolithic rotor or shaft 18. In an alternative embodiment, shaft 18 is segmented into a plurality of shaft segments wherein each shaft segment is coupled to an adjacent shaft segment to form shaft 18. Compressor 12 supplies compressed air to a combustor 20 where it mixes with fuel supplied via a stream 22.

In operation, air flows through compressor 12 and compressed air is supplied to combustor 20. Combustion gases 28 from combustor 20 propel turbine 14. Turbine 14 rotates shaft 18, compressor 12, and generator 16 about a longitudinal axis 30.

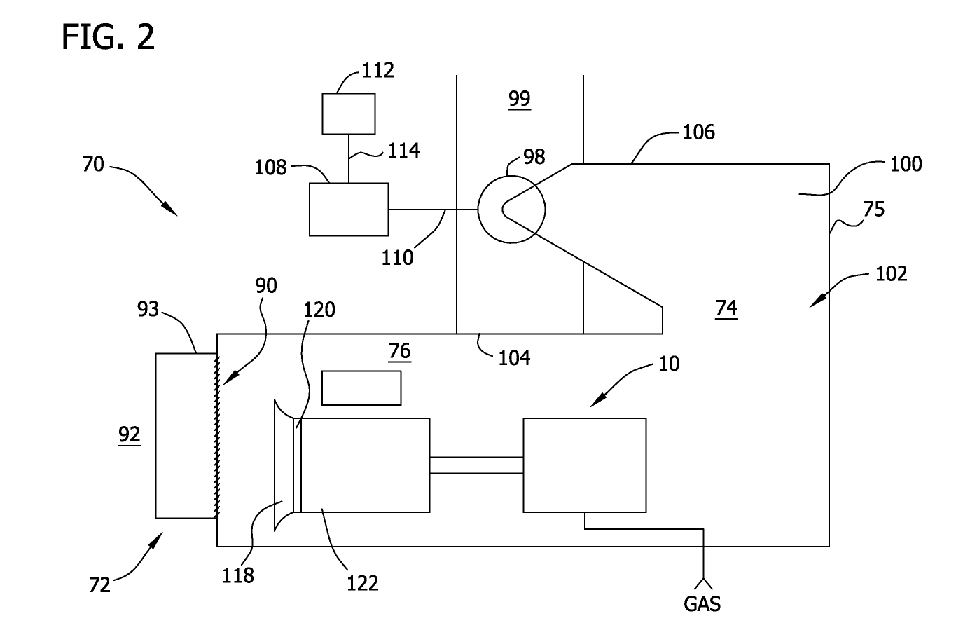

FIG. 2 is a schematic view of an exemplary gas turbine generator compartment 70 that may be used with gas turbine engine 10. In the exemplary embodiment, turbine generator compartment 70 includes an inlet portion 72, an exhaust portion 74 that is at least partially defined by an exhaust duct 75. An engine compartment area 76 extends between inlet portion 72 and exhaust portion 74. Engine compartment area 76 is sized to receive engine 10 therein. In the exemplary embodiment, inlet portion 72 includes an inlet duct damper 90 that is coupled in flow communication between engine compartment area 76 and a surrounding ambient air space 92 to receive ambient airflow therethrough. In the exemplary embodiment, an inlet filter housing 93 is positioned in the inlet duct 118 and contains filters (not shown) to facilitate reducing particulate and moisture carryover from the surrounding ambient air space 92. Alternatively, in another embodiment, the inlet duct 118 does not include an inlet filter housing 93 positioned in the inlet duct 118.

In the exemplary embodiment, exhaust duct 75 is coupled in flow communication with a fan housing 98. More specifically, a first end 100 of exhaust duct 75 is coupled to a discharge opening 102. In the exemplary embodiment, discharge opening 102 is defined in a ceiling 104 of compartment 70. A second end 106 of exhaust duct 75 is coupled to fan housing 98. As such, air entering engine compartment area 76 is discharged from compartment 70 through a fan discharge duct 99 coupled downstream from fan housing 98.

Fan housing 98 includes a fan rotor (not shown) that is rotationally coupled to a motor 108 through a shaft 110. A motor drive 112 controls operation of motor 108.

In operation, in the exemplary embodiment, air from the surrounding ambient air space 92 enters compartment area 76 through inlet filter housing 93 and damper 90. In the exemplary embodiment, gas turbine engine 10 includes an inlet duct 118 and a filter 120 coupled between duct 118 and an inlet 122 of gas turbine engine 10. Inlet duct 118 channels air from engine area 76 to engine inlet 122 through inlet filter 120. Inlet filter 120 further facilitates reducing the particulate and moisture entering inlet 122.

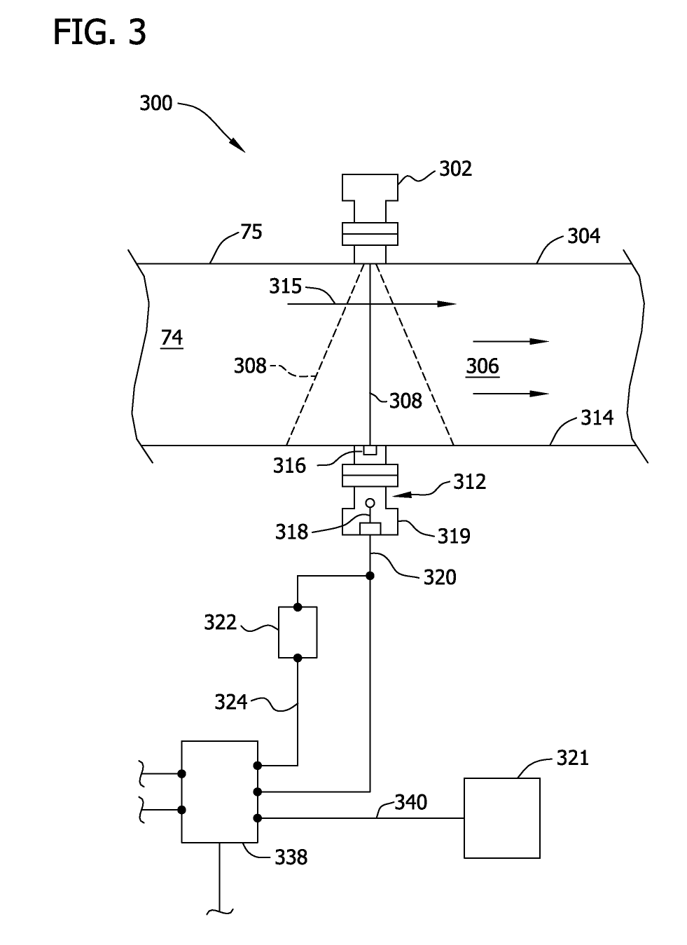

FIG. 3 is a schematic illustration of an exemplary particulate monitor system 300 that may be used with gas turbine engine 10 (shown in FIG. 1). In an exemplary embodiment, particulate monitor system 300 includes an emitter 302 that is coupled to exhaust duct 75 in an orientation that enables emitter 302 to function as described here. For example, in the exemplary embodiment, emitter 302 is coupled to a side wall 304 of exhaust duct 75 to be adjacent to, and in flow communication with combustion gases 306 flowing there through. Emitter 302 emits light, such as a beam of light 308, at a predetermined intensity, through the flow of gases 306 discharged from gas turbine engine 10 into exhaust duct 75. A receiver 312 is coupled within exhaust duct 75. For example, in the exemplary embodiment, receiver 312 is coupled opposite side 314 of duct 75 through emitter 302. Specifically, receiver 312 is oriented to receive at least a portion of light 308 emitted from emitter 302. In one embodiment, emitter 302 and receiver 312 are oriented such that the beam of light 308 is emitted through the flow of gases 306 at an oblique angle with respect to a center line axis 315 of duct 75. Because receiver 312 only needs to receive a portion of beam of light 308, the emitter 302 and receiver 312 may be oriented in any orientation that enables system 300 to function as described herein. Accordingly, emitter 302 and receiver 312 may be oriented at various angles with respect to each other, with respect to flow of gases 306, and with respect to center line axis 315. In the exemplary embodiment, light 308 is emitted in a highly collimated, narrowly-focused beam. Beam of light 308 may be, but not limited to only being, a laser beam or a diffuse and divergent beam.

In the exemplary embodiment, receiver 312 includes a sensor 316 that senses an intensity of the emitted light 308 received. A controller 319 coupled in communication with receiver 312 receives signals 318 from receiver 312 that correspond to the intensity of emitted light 308. Controller 319 generates an output signal 320 that corresponds to a variation in intensity of the emitted light 308. In the exemplary embodiment, a monitor 321 in communication with receiver 312 receives output signal 320 from controller 319.

In the exemplary embodiment, controller 319 includes a comparator 322. Comparator 322 compares the intensity of emitted light 308 detected by receiver 312 to a predetermined intensity of light emitted by the emitter. Controller 319 and/or comparator 322 generates an output or alarm signal 324 when the intensity of the emitted light 308 received by the receiver 312, controller 319 and/or comparator 322 is outside a predetermined band or threshold.

Comparator 322 generates an output or alarm signal 324 that is indicative of the intensity of the emitted beam of light 308 exceeding a predetermined selectable operating band or threshold, such as a high limit and/or a low limit. The detected intensity of the light 308 is at least partially determined by the amount of particulate flowing between the emitter 302 and receiver 312. For example, an increase in an amount of particulate passing between emitter 302 and receiver 312 yields a greater amount of “flicker” in the intensity of the emitted beam of light 308 and causes an intensity of beam of light 308 detected by receiver 312 to decrease.

In the exemplary embodiment, emitter 302 emits light in the infrared band of the electromagnetic spectrum. Alternatively, emitter 302 may emit light in any suitable band of the electromagnetic spectrum that enables system 300 to function as described herein. Moreover, in the exemplary embodiment, emitter 302 emits a modulated beam of light 308. The modulation of beam of light 308 facilitates eliminating or reducing any adverse effects of stray light, ambient light, and/or interference from gases in exhaust duct 75.

Processing circuit 338 combines output signals 320 and 324 through a selectable algorithm to generate an output signal 340 that is indicative of an amount of particulate in the flow of gases 306. For example, circuit 338 may use output signal 320 and/or output signal 324 to generate output signal 340. Moreover, circuit 338 may use other logic and/or process control functions to determine the amount of particulate entrained in the flow of gases 306 based on output signal 320 and/or output signal 324. In the exemplary embodiment, signals 320, 324 and/or 340 are transmitted to monitor 321.

In one embodiment, a method of monitoring particulate in a flow of gases is described. A beam of light, such as a beam of infrared light, is emitted by an emitter at a predetermined intensity into a flow of gases. At least a portion of the beam of light that is attenuated by particles in the flow of gases is detected by a receiver and a variation in intensity of the beam of light due to particle attenuation is determined by comparing the attenuated beam to the emitted beam. The variation in intensity is compared to a predetermined threshold value to generate an output signal indicative of an amount of particulate entrained in the flow of gases. The output signal is transmitted to a controller in communication with a remotely located monitor system. Upon receiving the output signal from the controller, the remotely located monitor system is able to continuously monitor an amount of particulate in the flow of gases.

The above-described embodiments of particulate monitor system provide a cost-effective and reliable means for determining the amount of particulate in the flow of gases of a gas turbine engine. As a result, the methods and system described herein facilitate operating equipment in a cost-effective and reliable manner. In an exemplary embodiment, the particulate monitor system provides monitoring particulate continuously and from a remote location.

Exemplary embodiments of particulate monitor systems are described above in detail. The systems are not limited to the specific embodiments described herein, but rather, components of each system may be utilized independently and separately from other components described herein. Each system component can also be used in combination with other system components.

While the invention has been described in terms of various specific embodiments, those skilled in the art will recognize that the invention can be practiced with modification within the spirit and scope of the claims.

What is claimed is:

1. A method of monitoring particulate in a flow of gases generated by a means for transportation, said method comprising:
emitting a beam of light at a predetermined intensity into the flow of gases;
detecting at least a portion of the beam of light that is attenuated by particles in the flow of gases;
determining, by comparing the attenuated beam to the emitted beam, a variation in intensity of the beam of light due to the particles attenuating the beam of light; and
comparing the variation to a predetermined threshold value to generate an output signal indicative of an amount of particulate entrained in the flow of gases.

2. A method in accordance with claim 1 further comprising transmitting the output signal to a remotely located monitor system.

3. A method in accordance with claim 2 further comprising receiving the output signal via a controller communicatively coupled to the remotely located monitor system.

4. A method in accordance with claim 1 further comprising continuously monitoring the amount of particulate in the flow of gases via a remotely located monitor system.

5. A method in accordance with claim 1, wherein emitting a beam of light comprises emitting a beam of infrared light.

6. A particulate monitor system monitoring particulate in a flow of gases generated by a means for transportation, said particulate monitoring system comprising:
an emitter coupled to an exhaust duct and downstream from a turbine engine, said emitter emits light at a predetermined intensity through the flow of gases discharged from the turbine engine to the exhaust duct;
a receiver coupled to the exhaust duct, said receiver is oriented to receive at least a portion of light emitted from said emitter, said receiver generates a first signal indicative of an intensity of the emitted light received;
a controller coupled in communication with said receiver, said controller configured to generate, based on the first signal, an output signal corresponding to a variation in intensity of the portion of the emitted light received; and
a monitor in communication with said controller, said monitor receives the output signal from said controller.

7. A system in accordance with claim 6 wherein the first signal generated by the receiver is representative of an amount of particulate entrained in the flow of gases.

8. A system in accordance with claim 6 wherein said controller comprises a comparator that compares the intensity of emitted light detected by said receiver to the predetermined intensity of light emitted by said emitter.

9. A system in accordance with claim 8 wherein said comparator generates an alarm signal when the intensity of the emitted light received by said receiver is below a predetermined threshold.

10. A system in accordance with claim 6 wherein said emitter emits light in the infrared band of the electromagnetic spectrum.

11. A system in accordance with claim 6 wherein said emitter emits a modulated beam of light that facilitates reducing at least one of stray light, ambient light, and interference from gases in the exhaust duct.

12. A system in accordance with claim 6 wherein said receiver further comprises a sensor that senses an intensity of the emitted light received.

13. A gas turbine engine system comprising:
a gas turbine engine comprising a combustion exhaust duct; and
a particulate monitor system comprising:
an emitter coupled to said exhaust duct downstream from said gas turbine engine, said emitter emits light at a predetermined intensity through a flow of gases discharged from said gas turbine engine;
a receiver coupled to said exhaust duct and oriented to receive at least a portion of light emitted from said emitter, said receiver generates a first signal indicative of an intensity of the emitted light received;
a controller coupled in communication with said receiver, said controller receives the first signal and generates an output signal corresponding to a variation in intensity of the emitted light; and
a monitor in communication with said controller, said monitor receives output signals from said controller.

14. A gas turbine engine system in accordance with claim 13 wherein the first signal generated by the receiver is representative of an amount of particulate entrained in the flow of gases.

15. A gas turbine engine system in accordance with claim 13 wherein said controller comprises a comparator that compares the intensity of the emitted light detected by said receiver to the predetermined intensity of light emitted by said emitter.

16. A gas turbine engine system in accordance with claim 15 wherein said comparator generates an alarm signal when the intensity of the emitted light received by said receiver is below a predetermined threshold.

17. A gas turbine engine system in accordance with claim 13 wherein said emitter emits light in the infrared band of the electromagnetic spectrum.

18. A gas turbine engine system in accordance with claim 13 wherein said emitter emits a modulated beam of light that facilitates reducing at least one of stray light, ambient light, and interference from gases in the exhaust duct.

19. A gas turbine engine system in accordance with claim 13 wherein said receiver further comprises a sensor that senses the intensity of the emitted light and generates the first signal indicative of the intensity of emitted light.

20. A gas turbine engine system in accordance with claim 13 further comprising an optical scintillation probe positioned in a wall of said exhaust duct to determine a distribution of particles in said exhaust duct using a variation in intensity of light detected from said emitter positioned on a wall of said exhaust duct.
